(19) United States
(12) Patent Application Publication
(10) Pub. No.: US 2007/0143471 A1
(43) Pub. Date: Jun. 21, 2007

(54) Methods, systems and computer program products for evaluating suitability of a network for packetized communications

(76) Inventors: Jeffrey T. Hicks, Cary, NC (US); Jeffrey L. McRee, Raleigh, NC (US); John L. Wood, Knoxville, TN (US)

Correspondence Address: MYERS BIGEL SIBLEY & SAJOVEC, PO BOX 37428, RALEIGH, NC, 27627, US

(21) Appl. No.: 11/312,910

(22) Filed: Dec. 20, 2005

(51) Int. Cl. G06F 15/173

(52) U.S. Cl. 709/224

(57) ABSTRACT

Methods, systems and computer program products are provided for evaluating suitability of a network for packetized communications, including identifying devices on the network and obtaining a plurality of assessment rules selected to evaluate the suitability of the network. Configuration data is obtained from the identified devices and the plurality of assessment rules are automatically evaluated using the obtained configuration data to evaluate the suitability of the network.

### BACKGROUND OF THE INVENTION

The present invention, generally, relates to network communication methods, systems and computer program products and, more particularly, to methods, systems and computer program products for evaluating such computer networks.

Companies are often dependent on mission-critical network applications to stay productive and competitive. To achieve this, information technology (IT) organizations preferably provide reliable application performance on a 24-hour, 7-day-a-week basis. One known approach to network performance testing to aid in this task is described in U.S. Pat. No. 5,881,237 (“the 237 patent”) entitled Methods, Systems and Computer Program Products for Test Scenario Based Communications Network Performance Testing. As described in the U.S. Pat. No. '237 patent, a test scenario simulating actual applications communication traffic on the network is defined. Various performance characteristics are measured while the test is executing. The resultant data may be provided to a console node, coupled to the network, which may also initiate execution of the test scenario by the various endpoint nodes.

One application area of particular interest currently is in the use of a computer network to support voice communications. More particularly, packetized voice communications are now available using data communication networks, such as the Internet and intranets, to support voice communications typically handled in the past over a conventional switched telecommunications network (such as the public switched telephone network (PSTN)). Calls over a data network typically rely on codec hardware and/or software for voice digitization so as to provide the packetized voice communications.

From a network perspective, evaluation for voice communications may differ from conventional data standards, particularly as throughput and/or response time may not be the critical measures. A VoIP phone call generally consists of two flows, one in each direction. Such a call typically does not need much bandwidth. However, the quality of a call (how it sounds) generally depends on three things: the one-way delay from end to end, how many packets are lost and whether that loss is in bursts, and the variation in arrival times, herein referred to as jitter.

In light of these differences, it may be desirable to determine if a network is even capable of supporting VoIP before deployment of such a capability. If the initial evaluation indicates that performance will be unsatisfactory or that existing traffic will be disrupted, it would be helpful to determine what to change in the network architecture to provide an improvement in performance for both VoIP and the existing communications traffic. As the impact of changes to various network components may not be predictable, thus requiring empirical test results, it would also be desirable to provide a repeatable means for iteratively testing a network to isolate the impact of individual changes to the network configuration.

### SUMMARY OF THE INVENTION

Embodiments of the present invention provide methods, systems and computer program products for evaluating suitability of a network for packetized communications. Devices on the network are identified. A plurality of assessment rules selected to evaluate the suitability of the network are obtained. Configuration data is obtained from the identified devices. The plurality of assessment rules are automatically evaluated using the obtained configuration data to evaluate the suitability of the network. The packetized communications may be packetized voice communications and/or packetized video communications.

In other embodiments, obtaining a plurality of assessment rules includes obtaining a rules data file and validating the obtained rules data file based on a predetermined schema. An error notification is generated when the obtained rules data file is not validated and the obtained rules data file is provided as the plurality of assessment rules when the obtained rules data file is validated. Evaluating the plurality of assessment rules may only be performed if the obtained rules data file is validated.

In further embodiments, the rules data file is an extensible markup language (XML) file and the predetermined schema is an XML schema definition. The assessment rules may be based on device type, device model, device operating system version, device installed memory and/or device installed modules and obtaining configuration data may include obtaining device type, device model, device operating system version, device installed memory and/or device installed modules data from the identified devices. The configuration data may be obtained using a simple network management protocol (SNMP) and/or an application program interface (API) supported by at least one of the identified devices.

In other embodiments, a sort order is determined based on device, result and/or rule and results from evaluating the plurality of assessment rules are reported in a format based on the determined sort order. Determining the sort order may include providing a graphic user interface (GUI) including a sort selection field configured to receive a user designation of the sort order and a results reporting field configured to display the formatted results and receiving a user designation of the sort order from the GUI.

In further embodiments, obtaining a plurality of assessment rules includes determining version information for a current set of assessment rules. An assessment rules source is queried to determine if updates are available for the current set of assessment rules based on the determined version information. Available updates are obtained to obtain the plurality of assessment rules. Obtaining available updates is performed before evaluating the plurality of assessment rules. Identifying devices on the network may include identifying devices not included in the current set of assessment rules and obtaining a plurality of assessment rules may include obtaining available assessment rules for identified devices not included in the current set of assessment rules from the assessment rules source. The assessment rules source may be a rules server and querying the assessment rules source and obtaining available updates may include communicating with the rules server using an internet protocol (IP) communication channel.

In yet other embodiments, the plurality of assessment rules include rules identifying devices with down-level operating system versions, identifying devices with insufficient memory and/or identifying devices without specified installed cards. Evaluating the plurality of assessment rules may be preceded by receiving a request to evaluate the network. Obtaining the plurality of assessment rules may include receiving an identification of a file and importing the identified file as the plurality of assessment rules.

In further embodiments, methods, systems and computer program products for providing assessment rules for evaluating suitability of a network for packetized communications include obtaining a plurality of device type associated assessment rules. A request for a plurality of assessment rules is received from a client device. The received request includes an identification of device types for which assessment rules are requested. Ones of the obtained plurality of device type associated assessment rules are identified that are associated with the device types identified in the received request. The identified ones of the obtained plurality of device type associated assessment rules are automatically provided to the client device responsive to the received request.

In other embodiments, ones of the obtained plurality of device type associated assessment rules have an associated rule identifier and rule version and the received request includes a rule identifier and a version of an assessment rule already available to the requesting client device. Identifying one of the obtained plurality of device type associated assessment rules includes only identifying an assessment rule having an associated rule identifier matching the received rule identifier when the rule version of the respective obtained assessment rule is greater than the version identified in the request for that rule identifier.

In further embodiments, obtaining a plurality of device type associated assessment rules includes obtaining assessment rules from a plurality of device vendors. Updated assessment rules are received from ones of the plurality of device vendors.

In yet other embodiments, systems for evaluating suitability of a network for packetized communications include a device identification module configured to identifying devices on the network. An input module of the systems is configured to obtain a plurality of assessment rules selected to evaluate the suitability of the network. A data acquisition module is configured to obtain configuration data from the identified devices and an evaluation module is configured to evaluate the plurality of assessment rules using the obtained configuration data to evaluate the suitability of the network.

In further embodiments, the input module is configured to obtain a rules data file. The system may further include a validation module configured to validate the obtained rules data file based on a predetermined schema and to generate an error notification when the obtained rules data file is not validated and provide the obtained rules data file as the plurality of assessment rules when the obtained rules data file is validated.

In other embodiments, systems for providing assessment rules for evaluating suitability of a network for packetized communications include an interface module and a rules identification module. The interface module is configured to obtain a plurality of device type associated assessment rules and to receive a request for a plurality of assessment rules from a client device. The received request includes an identification of device types for which assessment rules are requested. The rule identification module is configured to identify ones of the obtained plurality of device type associated assessment rules that are associated with the device types identified in the received request. The interface module is configured to provide the identified ones of the obtained plurality of device type associated assessment rules to the client device responsive to the received request.

While described above in part above with reference to methods, systems and computer program products are also provided in accordance with further embodiments of the present invention.

### BRIEF DESCRIPTION OF THE DRAWINGS

FIG. 1 is a block diagram of a hardware and software environment in which the present invention may operate according to some embodiments of the present invention;

FIG. 2 is a block diagram of a data processing system according to some embodiments of the present invention;

FIG. 3A is a more detailed block diagram of data processing systems for use in evaluating suitability of a network for packetized communications according to some embodiments of the present invention;

FIG. 3B is a more detailed block diagram of data processing systems for use in providing assessment rules for evaluating suitability of a network for packetized communications according to some embodiments of the present invention;

FIGS. 4-5 are flow charts illustrating operations for evaluating suitability of a network for packetized voice communications according to some embodiments of the present invention;

FIG. 6 is a flow chart illustrating operations for providing assessment rules for evaluating suitability of a network for packetized voice communications according to some embodiments of the present invention;

FIGS. 7-9 are graphical user interfaces according to some embodiments of the present invention;

FIG. 10 is an assessment report according to some embodiments of the present invention;

FIG. 11 is a rules data file according to some embodiments of the present invention; and

FIGS. 12A-12C are schematic diagrams of a rules schema for validating a rules data file according to some embodiments of the present invention.

### DETAILED DESCRIPTION OF THE INVENTION

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer-usable program code means embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java® or C++. However, the computer program code for carrying out operations of the present invention may also be written in conventional procedural programming languages, such as the “C” programming language or assembly language. The program code may execute entirely on the user's computer, partly on the user's computer, as a stand alone software package, partly on the user's computer and partly on a remote computer, or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified in the flowchart and/or block diagram block or blocks.

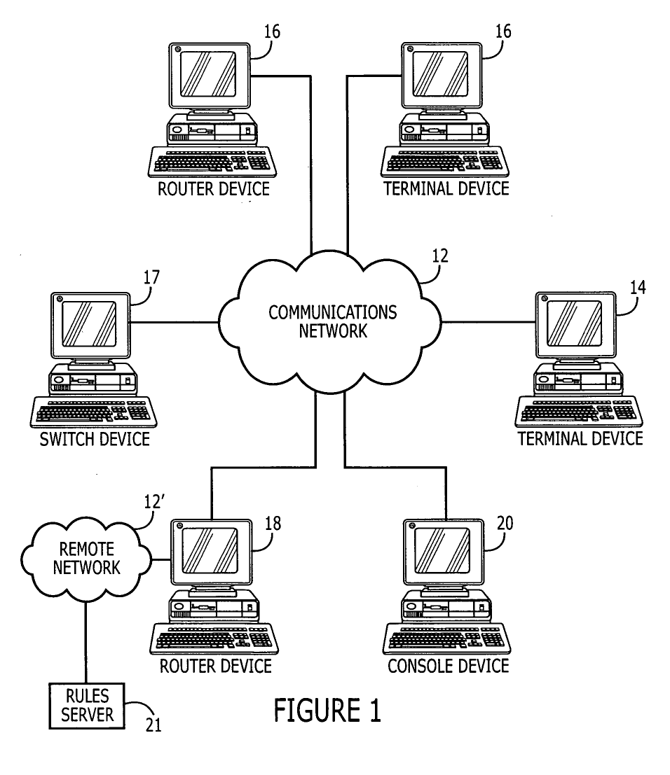

Some embodiments of the present invention will now be described with respect to FIGS. 1 through 12C below. Embodiments of the present invention provide methods, systems and computer program products for evaluating suitability of a network for packetized communications. Further embodiments of the present invention provide methods, systems and computer program products for providing assessment rules for evaluating suitability of a network for packetized communications.

Referring first to FIG. 1, a network environment and system for evaluating suitability of a network for packetized communications, such as packetized voice or video communications, according to some embodiments of the present invention will be further described. A hardware and software environment in which the present invention can operate as shown in FIG. 1 will now be described. As shown in FIG. 1, a communications network 12 includes and provides a communication link between terminal devices 14, 15, router devices 16, 18, switch device 17 and console device 20. The terminal devices 14, 15 may, for example, support packetized voice and/or video communications services for a user.

As will be understood by those having skill in the art, a communications network 12 may include of a plurality of separate linked physical communication networks, which, using a protocol such as the Internet protocol (IP), may appear to be a single seamless communications network to user application programs. For example, as illustrated in FIG. 1, remote network 12′ and communications network 12 may both include a communication node through a port of the router device 18. Accordingly, additional terminal devices or router/switch devices (not shown) on remote network 12′ may be made available for communications from devices on communications network 12. For some embodiments of the present invention, the network to be evaluated may be limited to the local network of a company or the like, which local network may communicate over the internet or the like with a rules server 21, shown as coupled to the remote network 12′ in FIG. 1.

It is further to be understood that, while for illustration purposes in FIG. 1 communications network 12 is shown as a single network, it may be comprised of a plurality of separate interconnected physical networks, one or more of which may be evaluated according to some embodiments of the present invention responsive to a request form a user. As illustrated in FIG. 1, the devices 14, 15, 16, 17, 18, 20, 21 may reside on a computer. As illustrated by router device 18, a single computer may be coupled to multiple networks (12, 12′).

Console node 20, or other means for controlling evaluation of the network 12, may obtain user input, for example, by keyed input to a computer terminal or through a passive monitor, to determine a desired test. Console node 20, or other control means may further identify devices on the network 12, obtain assessment rules for evaluating the network and evaluate identified devices based on the assessment rules. Console node 20 may initiate execution of network assessment and/or identification of network devices.

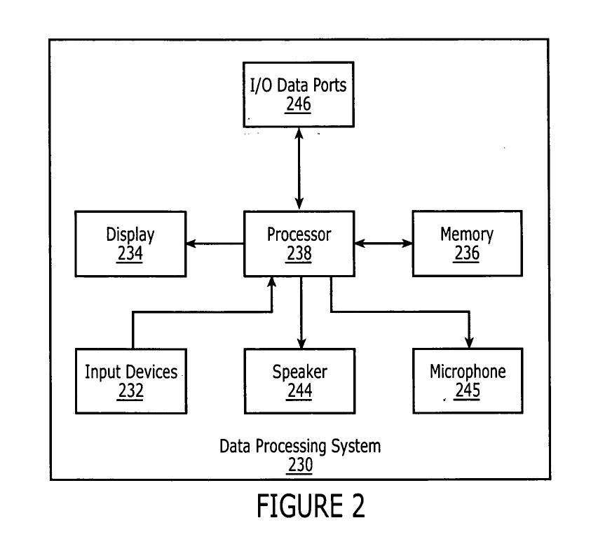

FIG. 2 illustrates an exemplary embodiment of a data processing system 230 in accordance with some embodiments of the present invention. The data processing system 230 typically includes input device(s) 232, such as a keyboard or keypad, a display 234, and a memory 236 that communicate with a processor 238. The data processing system 230 may further include a speaker 244, a microphone 245 and I/O data port(s) 246 that also communicate with the processor 238. The I/O data ports 246 can be used to transfer information between the data processing system 230 and another computer system or a network 12, for example, using an internet protocol (IP) connection. These components may be conventional components, such as those used in many conventional data processing systems which may be configured to operate as described herein.

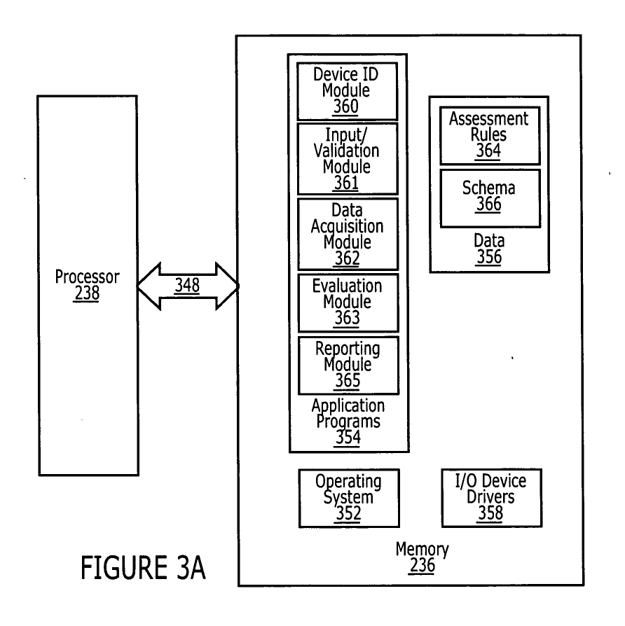

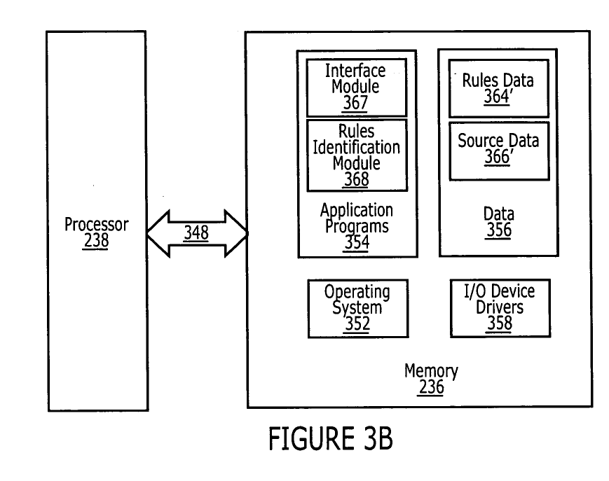

FIG. 3A is a block diagram of a data processing system that illustrates methods, systems and computer program products for evaluating suitability of a network for packetized communications in accordance with some embodiments of the present invention. FIG. 3B is a block diagram of a data processing system that illustrates methods, systems and computer program products for providing assessment rules for evaluating suitability of a network for packetized communications in accordance with some embodiments of the present invention. The processor 238 communicates with the memory 236 via an address/data bus 348. The processor 238 can be any commercially available or custom microprocessor. The memory 236 is representative of the overall hierarchy of memory devices containing the software and data used to implement the functionality of the data processing system 230. The memory 236 can include, but is not limited to, the following types of devices: cache, ROM, PROM, EPROM, EEPROM, flash memory, SRAM, and DRAM.

As shown in FIGS. 3A and 3B, the memory 236 may include several categories of software and data used in the data processing system 230: the operating system 352; the application programs 354; the input/output (I/O) device drivers 358; and the data 356. As will be appreciated by those of skill in the art, the operating system 352 may be any operating system suitable for use with a data processing system, such as Solaris from Sun Microsystems, OS/2, AIX or System390 from International Business Machines Corporation, Armonk, N.Y., Windows95, Windows98, Windows NT, Windows ME, Windows XP or Windows2000 from Microsoft Corporation, Redmond, Wash., Unix or Linux. The I/O device drivers 358 typically include software routines accessed through the operating system 352 by the application programs 354 to communicate with devices such as the input devices 232, the display 234, the speaker 244, the microphone 245, the I/O data port(s) 246, and certain memory 236 components. The application programs 354 are illustrative of the programs that implement the various features of the data processing system 230 and preferably include at least one application that supports operations according to embodiments of the present invention. Finally, the data 356 represents the static and dynamic data used by the application programs 354, the operating system 352, the I/O device drivers 358, and other software programs that may reside in the memory 236.

It will be understood that FIG. 3A illustrates a block diagram of data processing systems implementing a control device (console node) and/or other device controlling a network evaluation according to some embodiments of the present invention. Thus, the application programs 354 and the data 356 discussed with respect to FIG. 3A may be located in the console device 20 although it may also be implemented on another device coupled to the network 12 to be evaluated.

As illustrated in the embodiments of FIG. 3A, the application programs 354 may include a device identification module 360 that is configured to identify devices on the network 12 to be evaluated. In some embodiments, the identification may include sending and receiving communications over the network 12 so as to automatically discover devices on the network 12. In other embodiments, the device identification information may be provided and stored in a memory available to the device identification module 360, either locally in the memory 236 or on another device communicatively coupled to the device identification module 360. The communications may be transmitted and/or received through the I/O data ports 246, which provide a means for transmitting device discovery requests and also provide a receiver that receives, for example, over the network 12, identifying responses to the discovery requests. Device discovery operations are described further, for example, in commonly assigned United States Patent Application Publication No. US2004/0064760, published Apr. 1, 2004, entitled Methods, Systems and Computer Program Products for Assessing Network Quality, which is incorporated herein by reference in its entirety.

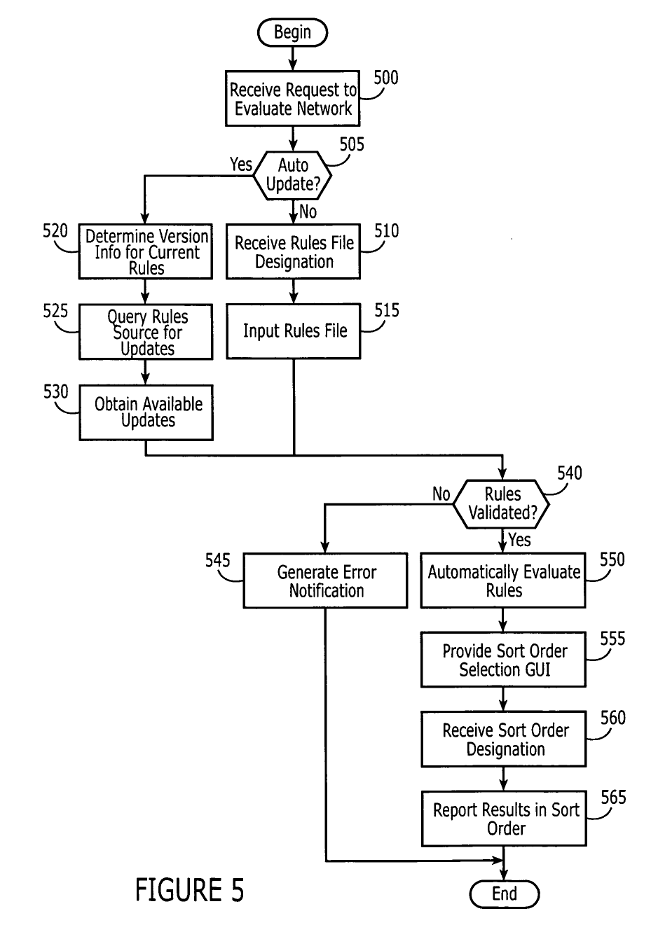

As illustrated in FIG. 3A, the application programs may also include an input/validation module 361. The input/validation module 361 in some embodiments is an input module configured to obtain a plurality of assessment rules selected to evaluate the suitability of the network or packetized communications. For example, as will be further described herein with reference to FIG. 5, the input module may obtain a rules data file and import such file and/or may obtain suitable updated rules from a rules server or the like. In some embodiments of the present invention, the input/validation module 361 is further configured to validate the obtained rules data file based on a predetermined schema and to generate an error notification when an obtained rules data file is not validated.

Additional application programs 354 illustrated in the embodiments of FIG. 3A include a data acquisition module 362, an evaluation module 363, and a reporting module 365. The data acquisition module 362 is configured to obtain configuration data from identified devices. The evaluation module 363 is configured to evaluate the assessment rules using the obtained configuration data to evaluate the suitability of the network for packetized communications. The reporting module 365, in some embodiments, may be configured to report the evaluation results through a graphical terminal interface, a report and/or the like.

The configuration data may be obtained from some or all of the devices on the network, for example, routers and switches. This data may be obtained from the network devices, for example, by simple network management protocol (SNMP) polling and/or an application program interface (API) supported by one or more of the network devices.

The data 356 illustrated in the embodiments of FIG. 3A includes assessment rules 364 and schema 366. For example, the assessment rules 364 may be a previously imported rules data file, such as an extensible markup language (XML) file. A plurality of such assessment rule files may be included that are, for example, associated with different users requesting evaluation of a network, with different types of packetized communication network evaluations and/or the like. The schema 366 may include a schema, such as an XML schema definition, that may be used by the input/validation module 361 to validate received rules data files.

Referring now to FIG. 3B, data processing systems for use in providing assessment rules for evaluating suitability of a network for packetized communications, such as a rules server, according to some embodiments of the present invention will now be further described. Like numbered elements in FIG. 3B correspond to the descriptions provided previously with reference to FIG. 3A, which descriptions will not be repeated herein. As shown in the embodiments of FIG. 3B, the application programs 354 include an interface module 367 and a rules identification module 368.

The interface module 367 is configured to obtain a plurality of device type associated assessment rules and to receive a request for a plurality of assessment rules from a client device. For example, the device type associated assessment rules may be obtained from respective manufacturers and/or vendors of the different device types and the requests for assessment rules or updates to assessment rules may be received from an administrator of a network subscribing to services from the system for providing assessment rules illustrated in FIG. 3B. The received request from the client device may include an identification of device types for which assessment rules are requested.

The rules identification module 368 is configured to identify ones of the obtained device type associated assessment rules that are associated with the device types identified in the received request. The interface module 367 may be configured to provide the identified ones of the obtained plurality of device type associated assessment rules to the client device responsive to received requests.

The data 356 illustrated for the embodiments of FIG. 3B includes rules data 364′ and source data 366′. The rules data 364′ may include various device type associated assessment rules previously obtained by the interface module 367. In addition to being device type associated, the assessment rules may further be associated with a particular form of packetized communications. For example, voice communication assessment rules may differ from video assessment rules. The source data 366′ may include identifications of the vendors or the like providing a source of initial and updated device type associated assessment rules. For example, the source data 366′ may identify Internet addresses associated with various vendors of equipment utilized in packetized communications configured networks.

While the present invention is illustrated, for example, with reference to the device identification module 360 and the other modules discussed above being application programs in FIG. 3A, as will be appreciated by those of skill in the art, other configurations may also be utilized for the various modules of FIGS. 3A and 3B described as application programs while still benefiting from the teachings of the present invention. For example, the device identification module 360 may also be incorporated into the operating system 352 or other such logical division of the data processing system 230. Thus, the present invention should not be construed as limited to the configuration of FIGS. 3A and 3B but is intended to encompass any configuration capable of carrying out the operations described herein.

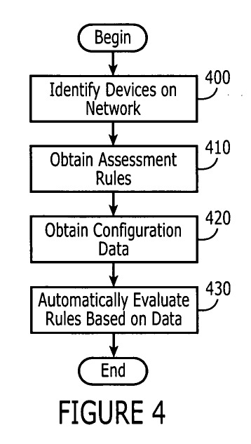

Operations for evaluating suitability of a network for packetized voice communications according to some embodiments of the present invention will now be further described with reference to the flowchart illustrations of FIGS. 4 and 5. As shown in the embodiments of FIG. 4, operations begin by identifying devices on the network to be evaluated (block 400). A plurality of assessment rules selected to evaluate the suitability of the network for packetized communications are obtained (block 410). Configuration data is obtained from the identified devices (block 420). A plurality of assessment rules are automatically evaluated using the obtained configuration data to evaluate the suitability of the network (block 430).

Obtaining assessment rules at block 410 may include obtaining a rules data file that may be an extensible markup language (XML) file. The assessment rules obtained at block 410 may be based, for example, on device type, device model, device operating system version and/or device installed memory. The obtained configuration data at block 420 may similarly include device type, device model, device operating system version and/or device installed memory data obtained from the identified devices. For example, the configuration data may be obtained from network devices using a simple network management protocol (SNMP) and/or an application program interface (API) supported by respective identified devices. It will be understood, however, that other types of configuration data may be obtained from a management information base (MIB) of a network device, such as a router or switch, as will be further described with reference to various examples provided herein may be obtained. The assessment rules may include rules, such as a rule identifying devices with down-level operating system versions, identifying devices with insufficient memory, identifying devices without specified installed cards, identifying devices having a security vulnerability and/or the like.

Methods of evaluating suitability of a network for packetized communications according to further embodiments of the present invention will now be described with reference to the flowchart illustration of FIG. 5. As shown in the embodiments of FIG. 5, operations for evaluating a network may begin with receipt of a request to evaluate the network (block 500). However, it will be understood that the evaluation of the network may be otherwise scheduled to occur automatically, for example, responsive to addition, removal and/or modification of devices on a network.

In some embodiments of the present invention not involving automatic updating of assessment rules through a rules server or the like (block 505), an identification of a rules file is received (block 510). The identified file is imported for use as the network assessment rules (block 515).

For some embodiments of the present invention including automated rule updates through a rules server or the like (block 505), version information for a current set of assessment rules is determined (block 520). An assessment rules source, such as a rules server as illustrated in FIG. 3B, is queried to determine if updates are available for the current set of assessment rules based on the determined version information (block 525). Available updates are obtained to provide the assessment rules for use in evaluating the network (block 530). In addition to querying for (block 525) and obtaining (block 530) updated assessment rules corresponding to earlier version assessment rules included in a current set of rules, identified devices on the network may include devices not included in the current set of assessment rules and operations at block 530 may include obtaining available assessment rules for identified devices not included in the current set of assessment rules from the assessment rules source. The assessment rules source, such as a rules server, may be queried and the available updates may be obtained by communicating with the rules server using an Internet protocol (IP) communication channel at blocks 525 and 530.

The obtained assessment rules may be validated based on a predetermined schema (block 540). For example, the assessment rules may be an extensible markup language (XML) rules data file and the predetermined schema may be an XML schema definition. An error notification may be generated when the obtained rules data file is not validated (block 545). For the embodiments in FIG. 5, when an error notification is generated at block 545, operations cease and the assessment rules are not evaluated.

When the obtained rules data file is validated (block 540), the plurality of assessment rules are automatically evaluated using the obtained configuration data to evaluate the suitability of the network (block 550). It will be understood that obtaining of the configuration data as described with reference to block 420 of FIG. 4 may occur before and/or after obtaining assessment rules and/or before or after validating obtained assessment rules.

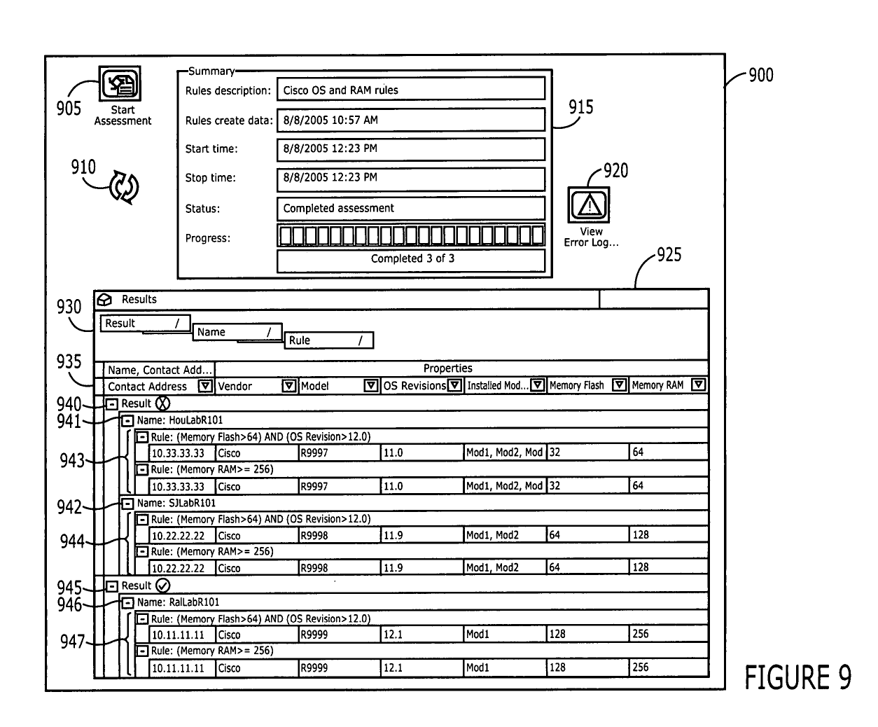

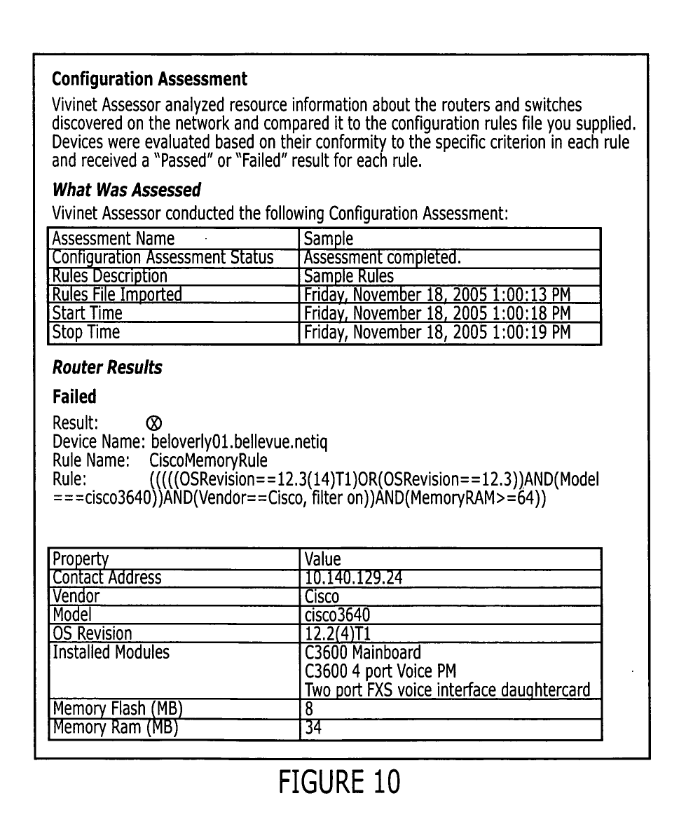

The embodiments illustrated in FIG. 5 further illustrate various reporting operations for reporting evaluation results as will now be described with reference to blocks 555-565. In the illustrated reporting operations, a graphic user interface (GUI) including a sort selection field is provided that is configured to receive a user designation of the sort order and a results reporting field configured to display formatted results (block 565). A sort order for the results is determined based on a device, result, and/or rule based on a user designation received through the GUI provided at block 555 (block 560). The results of the evaluation of the assessment rules are reported in a format based on the determined sort order (block 565). An example of a sorted report presented through a GUI to a requesting user is illustrated in FIG. 9 as will be described further later herein. An exemplary configuration assessment report that may be saved by a user to a file and/or printed is illustrated in FIG. 10.

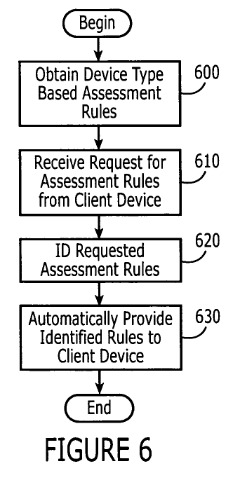

Methods for providing assessment rules for evaluating suitability of a network or packetized communications, such as packetized voice communications and/or packetized video communications, according to some embodiments of the present invention will now be described with reference to the flowchart illustration of FIG. 6. As shown in the embodiments of FIG. 6, operations begin with obtaining a plurality of device type associated assessment rules (block 600). A request for a plurality of assessment rules is received from a client device (block 610). The received request may include an identification of device types for which assessment rules are requested. The identification in a received request may include a rule identifier, such as a unique rule number, and a version of an assessment rule already available to the requesting client device.

Ones of the obtained plurality of device types associated assessment rules from block 600 that are associated with the device types identified in the received request at block 610 are identified (block 620). In some embodiments, identifying operations at block 620 include identifying ones of the device type associated assessment rules obtained at block 600 that include a rule version newer than the version identified in the request received at block 610 for a given rule identifier associated assessment rule. In other words, the rule identifier included in the request may be a unique rule identifier and its associated version number can be matched to a corresponding identified rule obtained at block 600 to determine if an updated, later rule version number version of a given rule is available that has a more recent release version number than the version already available to the requesting client device. For example, a rules server that obtains device type based assessment rules at block 600 may obtain the assessment rules from a plurality of different device vendors and receive updated assessment rules from one or more of the device vendors on a periodic and/or otherwise scheduled basis. The updated version numbers may increase with each update so that a client device that last received assessment rules from the rules server before new updates were provided by device vendors may receive newer versions of the rules responsive to a request. Such a selective provision of new rules may limit the amount of traffic between the client device and the rules server.

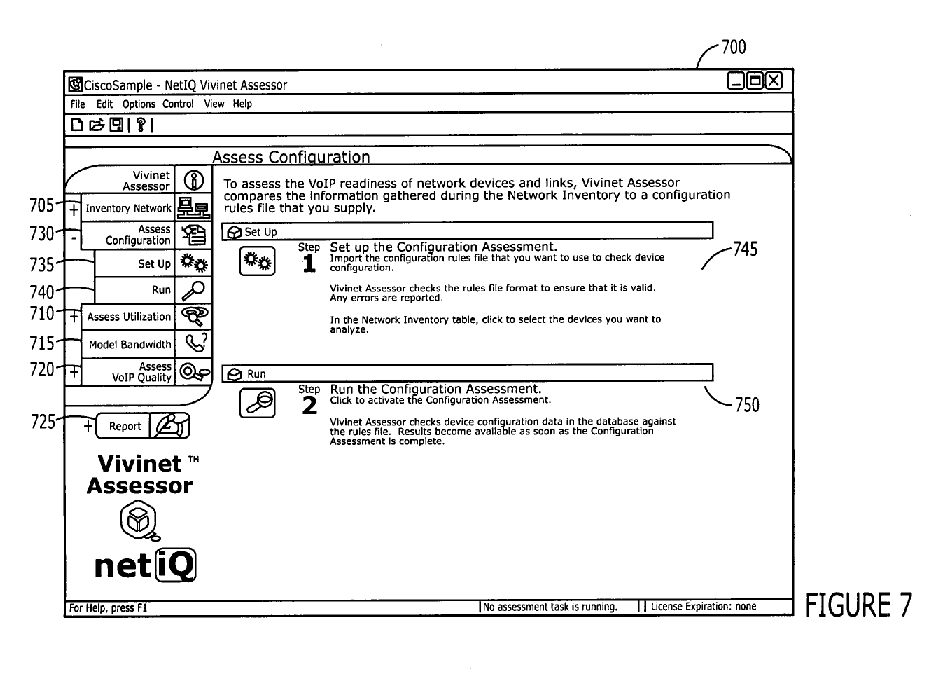

Embodiments of the present invention for evaluating suitability of a network may provide many user configurable options for evaluating an existing network. The network may be assessed on an ongoing basis, may be assessed before initial deployment of the desired traffic on the network and/or may be assessed when devices on the network are changed, removed and/or new devices are added. Embodiments of the present invention may provide a user-friendly graphical user interface (GUI) that walks the user through the operations of the present invention as will be discussed with respect to FIGS. 7-9.

As illustrated in FIG. 7, a GUI, according to some embodiments of the present invention, may provide a list of tasks down the left hand side of the window. The GUI may also provide a view area for each corresponding task on the list, which may make it less likely that a user will make an unintended or premature selection. It will be understood that the GUI 700 illustrated in FIG. 7 is provided for exemplary purposes only and that GUIs according to embodiments of the present invention are not limited to the GUIs illustrated herein.

As illustrated in the exemplary window of FIG. 7, network suitability assessment for packetized services, such as VoIP, may be beneficially integrated with obtaining an inventory of network devices/links, assessing utilization of those devices/links and modeling the bandwidth of the communication links defined by the network devices to, for example, estimate the call capacity of the network links. In addition, it is to be understood that the overall configuration of the network could also be assessed for suitability for a particular type of packetized communications, such as VoIP or streaming video. For example, model and operating system version information about devices on the network could be used as a basis to determine the suitability of the network independent of assessments based on utilization or quality.

While each of these operations may be beneficially applied to network analysis, the GUI illustrated in FIG. 7 is arranged to facilitate a particular flow of operations based on interrelationships between these distinct activities. Thus, the Inventory Network button 705, Assess Configuration button 730, Assess Utilization button 710, Model Bandwidth button 715 and Assess VoIP Quality button 720 are located sequentially adjacent each other extending down along the left hand side of the GUI 700. However, it will be understood that not all of the illustrated assessment operations need be provided and that the sequential ordering of the tasks need not require that the tasks be completed in the indicated sequence.

As shown in FIG. 7, the Assess Configuration button 730 has been selected, thereby displaying the associated Set Up button 735 and Run button 740. In addition, explanatory information associated with Set Up is shown in an information field 745 and explanatory information regarding the Run operation is shown in an information field 750.

The Report button 725 is located below the analysis operation buttons 705, 730, 710, 715 and 720. The Report button 725 may provide a single interface for user initiated reports based on information from any of the provided assessments. Thus, some embodiments of the present invention may provide a result summary providing a synopsis of the results of the network assessment. The result summary may include, but is not limited to, an indication of overall network suitability and evaluation results as will be described further herein. The summary may be provided in a format, for example, a text format, that may be displayed on a computer screen or printed on a printer and/or photocopier. These result summaries or reports may provide a simplified method of explaining and summarizing the results of a network performance test.

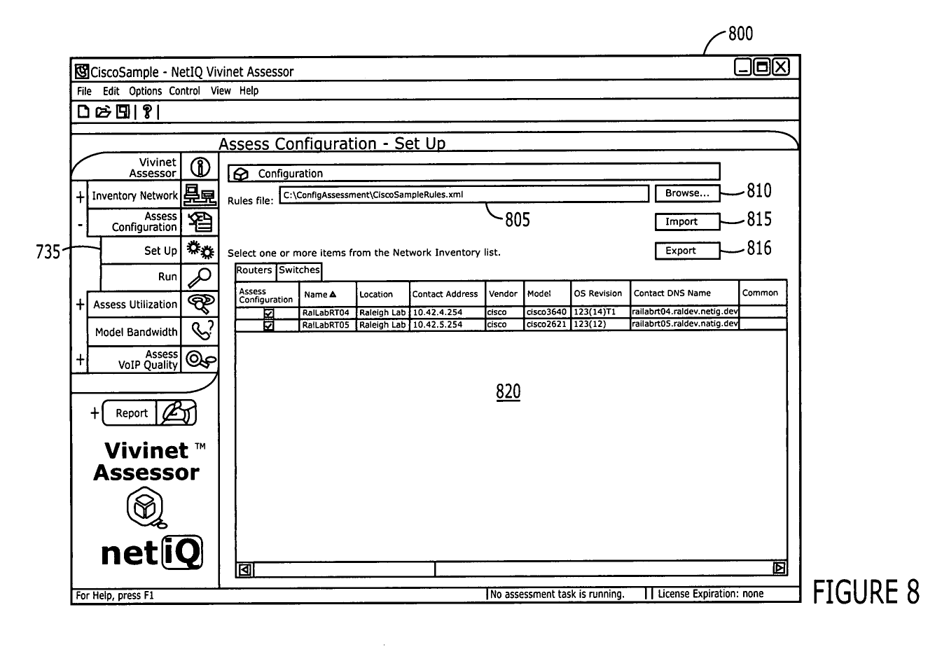

FIG. 8 illustrates embodiments of a GUI 800 that may be generated when the Set Up button 735 is selected. As seen in the GUI 800, a user may select a file as identified in the rules file field 805 and have a displayed rules file imported by selecting the import button 815. Rules files may also be exported in the illustrated embodiments using an export button 816. In addition, the Browse button 810 can be selected to allow a user to browse through file listings to select the rules file to be imported. In addition, a device selection field 820 is shown in the embodiments of FIG. 8. As seen in the embodiments of FIG. 8, different device types may be selected and displayed by a separate tab, such as a routers, switches, and the like, and then specific devices of the router and/or switch type may be selected for evaluation by checking the Assess Configuration box associated with each such device in the device selection field 820.

FIG. 9 illustrates a GUI 900 that may be generated in response to selection of the Run button 740 illustrated in FIG. 7. As seen in the GUI 900 for the embodiments of FIG. 9, a Start Assessment button 905 is presented for selection by a user to initiate evaluation of a network using the designated assessment rules file input using the GUI 800 of FIG. 8. Arrow icons 910 may graphically illustrate progress of an assessment after selection of the Start Assessment button 905 by a user. In addition, a summary field 915 is shown in the embodiments of FIG. 9 providing summary information regarding the currently underway assessment and the progress thereof. Where errors occur, an error report may be generated for viewing by a user through selection of the View Error Log button 920.

In addition, a results field 925 is shown in the embodiments of FIG. 9, where the information in the results field 925 may be updated and presented on completion of an assessment. As described with reference to blocks 555-565 of FIG. 5, the illustrated results field 925 shows formatted results based on a determined sort order, shown as results, name, and rule in the example of FIG. 9. Thus, the results are sorted and tree selectable based on the user selection of ordering of the result, name, and rule sort designators in the sort selection field 930. The failed results are listed under the result field 940, while the past results are listed under the result field 945. For the failed results 940, a first device 941 and second device 942 are shown. Two specific failed rules 943 are displayed for the first device 941 and two specific failed rules 944 are shown for the second device 942 in the embodiments of FIG. 9. Furthermore, a first device 946 and two passed rules 947 for that device 946 are shown under the passed results field 945. Finally, additional information and designation of headers for various property columns are shown in field 935. A result report in file savable or printable format is illustrated in FIG. 10.

A rule may “fail” because it does not apply to the device being evaluated or because it applies but the device fails to meet a criterion for that device. As such, each property that can be checked by a rule (e.g. vendor, device type, operating system version, etc.) can, in some embodiments, have an attribute specified in the XML rules file that determines whether or not the property is checked for purposes of being flagged as “failed” during an evaluation. For example, a “FilterOn” keyword may added to the XML rules file for a particular property. If the FilterOn keyword is “true,” then this particular property will not cause the entire rule to be classified as failed for the evaluation. By way of more particular example, devices from multiple vendors may be included in a network being evaluated. A user may want to perform certain checks for one vendor device and other checks for another vendor. As such, the user generally will not want the vendor property check to fail, otherwise all of vendor A devices would fail the rules associated with vendor B and vice versa. Specifying FilterOn=true, allows these vendor checks to be filtered so they do not fail.

Another rule checking comparison included in some embodiments is a “Find” comparison operator. The Find comparison may be used to allow a user to search for certain text strings within a property value. For example, some of the installed module property values for a device may have serial numbers in the value. A user may not know or care about a particular serial number, but may want to find certain types of cards. The Find operator may be configured to look for a specific substring within the entire property value string.

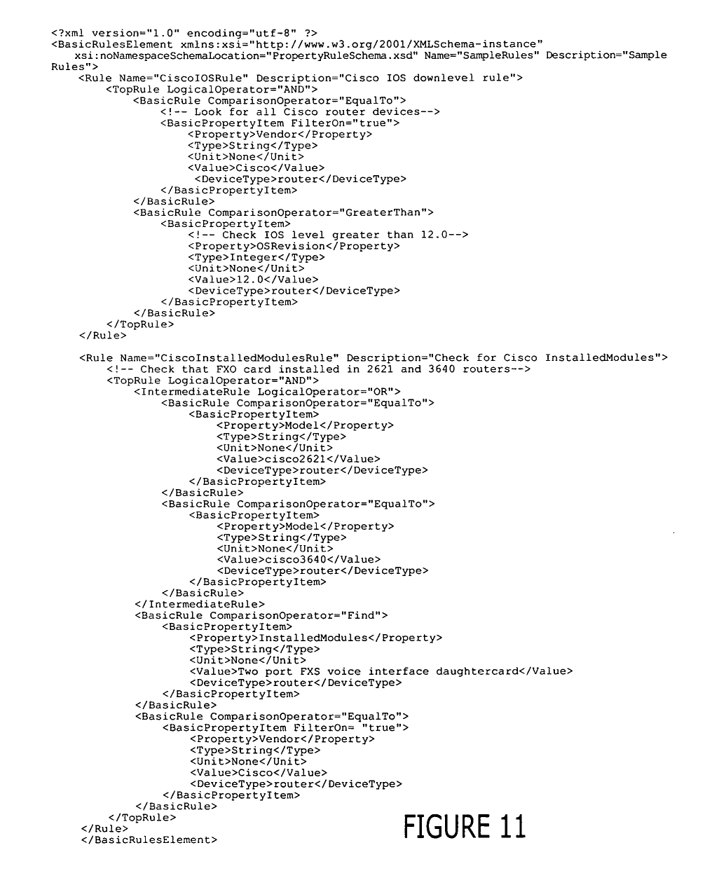

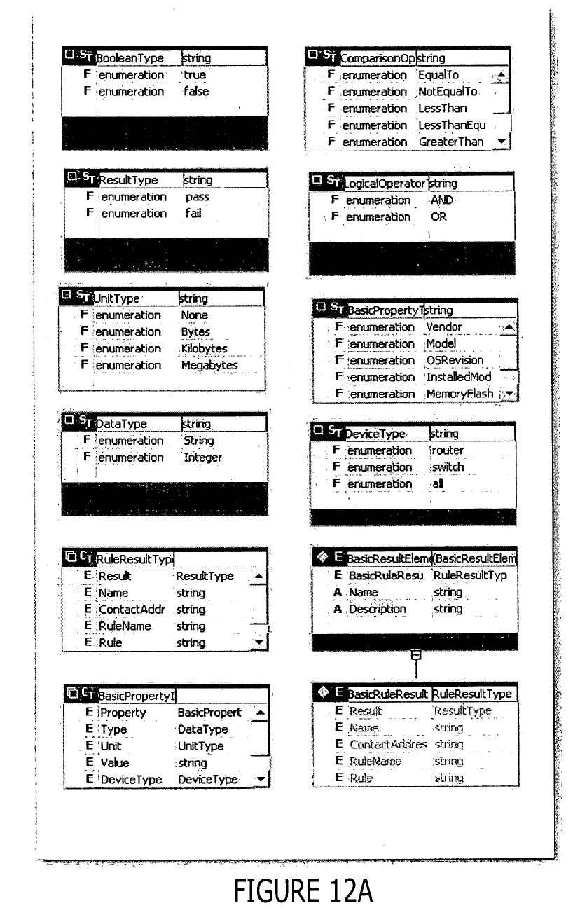

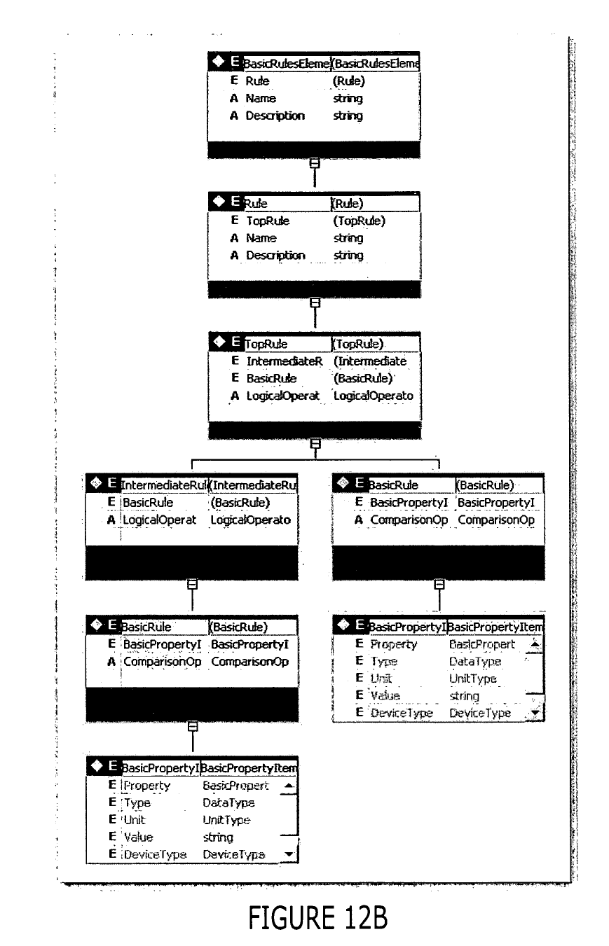

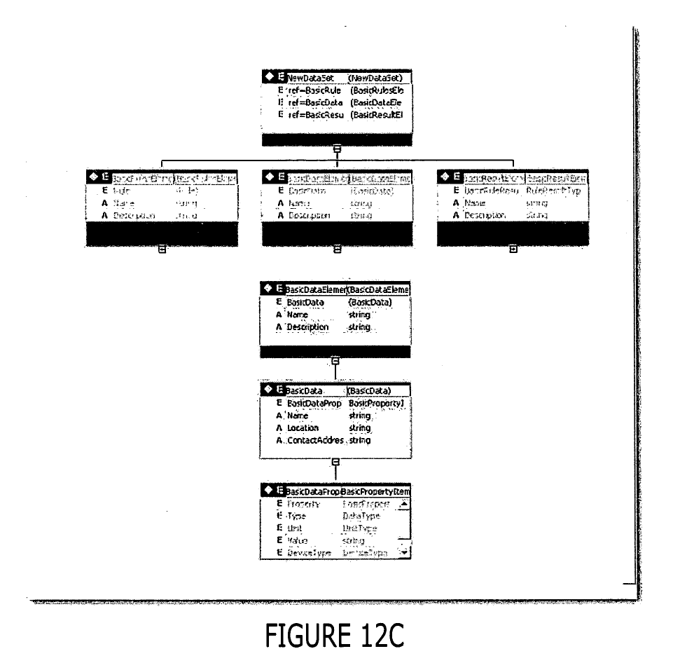

As noted above, in some embodiments of the present invention, the rules data file may be an XML file. FIG. 11 illustrates one exemplary rules file in XML format that may be used for evaluating suitability of a network for voice over Internet protocol (VoIP) packetized communications. As also noted above, a rule schema for the XML file may be used to validate the rules. An exemplary rule schema is illustrated graphically in the schematic diagrams of FIGS. 12A-12C.

As described above, some embodiments of the present invention provide methods, systems and computer programs for automatically applying a rules-based approach to analyzing configuration properties of network devices, such as routers and switches, for a network to be used for packetized communications. The network device information itself may be collected during an initial discovery phase and different configuration properties can be automatically assessed to determine if the devices are ready for packetized communications, for example, VoIP service deployment on the network.

As further described above, an XML schema definition may be provided to give users a framework for creating simple rules and combinations of rules. A user provided XML file may then specify the rules to be applied to each device type and the rules may be chained together using logical operators. Some example scenarios may include identifying devices with down-level operating system (OS) versions or insufficient memory; identifying device models and their OS or memory requirements; and/or identifying devices with certain hardware installed.

Thus, tools may be provided for automatically assessing the readiness of a network by checking each network device to determine if the device is ready for packetized communications, such as VoIP communications, if a network provider wishes to ensure effective traffic performance before introducing such capabilities. The automated approach as provided by various embodiments of the present invention may greatly expedite the preparation and analysis of a network before deployment of such new services over the network.

The rules can be simple or complicated, for example, as simple as checking a single property of a particular device. For example, all routers may be required to be using an OS level greater than 12.0. Other checks could be very complicated, involving multiple properties. For example, checks could be run to determine if all devices with a model of 3640 and OS level 12.0 have a memory greater than at least 64 MB.

In addition, the rules information may be changed and/or updated on a regular basis. The rules update may be user driven and/or may be provided by a rules server or the like that provides a central tracking point for rules update distribution from a plurality of different equipment vendors to make the rules update process even more expeditious for users in assessing and evaluating their networks.

Accordingly, an infrastructure may be provided by some embodiments of the present invention for automatically assessing, using a rules-based approach, any number of configuration properties for a number of devices. Rules files can be modified as rules change or get updated. The rules can be applied automatically to some or all designated devices via a user interface. The user interface may then graphically show which device has passed or failed and the associated rules tested resulting in either pass or fail results.

As described above with respect to FIGS. 1 through 12C, the present invention describes methods, systems and computer program products for evaluating suitability of a network for packetized communications and/or providing rules for such an evaluation.

It will be understood that the block diagram of FIGS. 1-3 and combinations of blocks in the block diagrams may be implemented using discrete and integrated electronic circuits. It will also be appreciated that blocks of the block diagram of FIGS. 1-3 and combinations of blocks in the block diagrams may be implemented using components other than those illustrated in FIGS. 1-3, and that, in general, various blocks of the block diagrams and combinations of blocks in the block diagrams, may be implemented in special purpose hardware such as discrete analog and/or digital circuitry, combinations of integrated circuits or one or more application specific integrated circuits (ASICs).

Accordingly, blocks of the block diagrams of FIGS. 1-3 and the flowcharts of FIGS. 4-6 support electronic circuits and other means for performing the specified operations, as well as combinations of operations. It will be understood that the circuits and other means supported by each block and combinations of blocks can be implemented by special purpose hardware, software or firmware operating on special or general purpose data processors, or combinations thereof. It should also be noted that, in some implementations, the operations noted in the blocks may occur out of the order noted in the figures. For example, two blocks shown in succession may, in fact, be executed substantially concurrently, or the blocks may sometimes be executed in the reverse order.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed:

1. A computer implemented method of evaluating suitability of a network for packetized communications, the method comprising:
identifying devices on the network;
obtaining a plurality of assessment rules selected to evaluate the suitability of the network;
obtaining configuration data from the identified devices; and
automatically evaluating the plurality of assessment rules using the obtained configuration data to evaluate the suitability of the network.

2. The method of claim 1, wherein the packetized communications comprise packetized voice communications and/or packetized video communications.

3. The method of claim 2, wherein obtaining a plurality of assessment rules comprises:
obtaining a rules data file;
validating the obtained rules data file based on a predetermined schema; and
generating an error notification when the obtained rules data file is not validated and providing the obtained rules data file as the plurality of assessment rules when the obtained rules data file is validated.

4. The method of claim 3, wherein evaluating the plurality of assessment rules is only performed if the obtained rules data file is validated.

5. The method of claim 3, wherein the rules data file comprises an extensible markup language (XML) file and wherein the predetermined schema comprises an XML schema definition.

6. The method of claim 2, wherein the assessment rules are based on device type, device model, device operating system version, device installed memory and/or device installed modules and wherein obtaining configuration data comprises obtaining device type, device model, device operating system version, device installed memory and/or device installed modules data from the identified devices.

7. The method of claim 2, wherein obtaining configuration data comprises obtaining the configuration data using a simple network management protocol (SNMP) and/or an application program interface (API) supported by at least one of the identified devices.

8. The method of claim 2, further comprising:
determining a sort order based on device, result and/or rule; and
reporting results from evaluating the plurality of assessment rules in a format based on the determined sort order.

9. The method of claim 8, wherein determining a sort order comprises:
providing a graphic user interface (GUI) including a sort selection field configured to receive a user designation of the sort order and a results reporting field configured to display the formatted results; and
receiving a user designation of the sort order from the GUI.

10. The method of claim 2, wherein obtaining a plurality of assessment rules comprises:
determining version information for a current set of assessment rules;
querying an assessment rules source to determine if updates are available for the current set of assessment rules based on the determined version information; and
obtaining available updates to obtain the plurality of assessment rules;
wherein obtaining available updates is performed before evaluating the plurality of assessment rules.

11. The method of claim 10, wherein identifying devices on the network includes identifying devices not included in the current set of assessment rules and wherein obtaining a plurality of assessment rules includes obtaining available assessment rules for identified devices not included in the current set of assessment rules from the assessment rules source.

12. The method of claim 10, wherein the assessment rules source comprises a rules server and wherein querying the assessment rules source and obtaining available updates comprise communicating with the rules server using an internet protocol (IP) communication channel.

13. The method of claim 2, wherein the plurality of assessment rules include a rule identifying devices with down-level operating system versions, identifying devices with insufficient memory and/or identifying devices without specified installed cards.

14. The method of claim 2, wherein evaluating the plurality of assessment rules is preceded by receiving a request to evaluate the network.

15. The method of claim 2, wherein obtaining the plurality of assessment rules comprises:
receiving an identification of a file; and
importing the identified file as the plurality of assessment rules.

16. The method of claim 2, wherein ones of the assessment rules include a filter keyword identifying a type of the configuration data that will not cause the ones of the assessment rules to be classified as failed when automatically evaluating the plurality of assessment rules.

17. A computer program product for evaluating suitability of a network for packetized communications, the computer program product comprising computer program code embodied in a computer readable medium, the computer program code comprising program code configured to carry out the method of claim 3.

18. A system configured to carry out the method of claim 3.

19. A method for providing assessment rules for evaluating suitability of a network for packetized communications, comprising:
obtaining a plurality of device type associated assessment rules;
receiving a request for a plurality of assessment rules from a client device, the received request including an identification of device types for which assessment rules are requested;
identifying ones of the obtained plurality of device type associated assessment rules that are associated with the device types identified in the received request; and
automatically providing the identified ones of the obtained plurality of device type associated assessment rules to the client device responsive to the received request.

20. The method of claim 19, wherein ones of the obtained plurality of device type associated assessment rules have an associated rule identifier and rule version and wherein the received request includes a rule identifier and a version of an assessment rule already available to the requesting client device and wherein identifying one of the obtained plurality of device type associated assessment rules includes only identifying an assessment rule having an associated rule identifier matching the received rule identifier when the rule version of the respective obtained assessment rule is greater than the version identified in the request for that rule identifier.

21. The method of claim 19, wherein obtaining a plurality of device type associated assessment rules comprises:
obtaining assessment rules from a plurality of device vendors; and
receiving updated assessment rules from ones of the plurality of device vendors.

22. A computer program product for evaluating suitability of a network for packetized communications, the computer program product comprising computer program code embodied in a computer readable medium, the computer program code comprising program code configured to carry out the method of claim 19.

23. A system configured to carry out the method of claim 19.

24. A system for evaluating suitability of a network for packetized communications, the system comprising:
a device identification module configured to identify devices on the network;
an input module configured to obtain a plurality of assessment rules selected to evaluate the suitability of the network;
a data acquisition module configured to obtain configuration data from the identified devices; and
an evaluation module configured to evaluate the plurality of assessment rules using the obtained configuration data to evaluate the suitability of the network.

25. The system of claim 24, wherein the packetized communications comprise packetized voice communications and/or packetized video communications.

26. The system of claim 25, wherein the input module is configured to obtain a rules data file and wherein the system further comprises a validation module configured to validate the obtained rules data file based on a predetermined schema and to generate an error notification when the obtained rules data file is not validated and provide the obtained rules data file as the plurality of assessment rules when the obtained rules data file is validated.

27. The system of claim 25, wherein the rules data file comprises an extensible markup language (XML) file and wherein the obtained rules data file comprises an XML schema definition.

28. A system for providing assessment rules for evaluating suitability of a network for packetized communications, comprising:
an interface module configured to obtain a plurality of device type associated assessment rules and to receive a request for a plurality of assessment rules from a client device, the received request including an identification of device types for which assessment rules are requested; and
a rule identification module configured to identify ones of the obtained plurality of device type associated assessment rules that are associated with the device types identified in the received request, wherein the interface module is configured to provide the identified ones of the obtained plurality of device type associated assessment rules to the client device responsive to the received request.

29. A computer program product for evaluating suitability of a network for packetized communications, the computer program product comprising:
a computer-readable storage medium having computer-readable program code embodied in said medium, said computer-readable program code comprising:
computer-readable program code that identifies devices on the network;
computer-readable program code that obtains a plurality of assessment rules selected to evaluate the suitability of the network;
computer-readable program code that obtains configuration data from the identified devices; and
computer-readable program code that evaluates the plurality of assessment rules using the obtained configuration data to evaluate the suitability of the network.

30. A computer program product for providing assessment rules for evaluating suitability of a network for packetized communications, the computer program product comprising:
a computer-readable storage medium having computer-readable program code embodied in said medium, said computer-readable program code comprising:
computer-readable program code that obtains a plurality of device type associated assessment rules;
computer-readable program code that receives request for a plurality of assessment rules from a client device, the received request including an identification of device types for which assessment rules are requested;
computer-readable program code that identifies ones of the obtained plurality of device type associated assessment rules that are associated with the device types identified in the received request; and
computer-readable program code that automatically provides the identified ones of the obtained plurality of device type associated assessment rules to the client device responsive to the received request.
